(19) United States
(12) Patent Application Publication
(10) Pub. No.: US 2019/0127955 A1
(43) Pub. Date: May 2, 2019

(54) CONTROL SYSTEM FOR HYBRID CONSTRUCTION MACHINE

(71) Applicant: KYB Corporation, Tokyo (JP)

(72) Inventor: Masahiro EGAWA, Saitama (JP)

(73) Assignee: KYB Corporation, Tokyo (JP)

(21) Appl. No.: 16/095,464

(22) PCT Filed: May 16, 2017
(86) PCT No.: PCT/JP2017/018396

§ 371 Date: Oct. 22, 2018

(30) Foreign Application Priority Data
May 23, 2016 (JP) 2016-102747

(51) Int. Cl. E02F 9/20; F15B 21/14; E02F 9/22

(52) U.S. Cl. CPC E02F 9/2075; F15B 2211/20546; E02F 9/2232; F15B 21/14

(57) ABSTRACT

A control system for a hybrid construction machine includes: a first main pump and a second main pump; a regeneration motor configured to rotationally drive by returned working oil; a motor generator coupled to the regeneration motor; an assist pump coupled to the regeneration motor and the motor generator; and a controller. The controller controls the assist pump or the motor generator such that the assist pump drive force is not more than the drive force limited value when an assist pump drive force is greater than a drive force limited value.

### TECHNICAL FIELD

The present invention relates to a control system for a hybrid construction machine.

### BACKGROUND ART

JP2014-37861A discloses a hybrid construction machine in which an electric motor to be driven by electric power of a battery and an engine are used in combination as a power source. In this hybrid construction machine, a regeneration motor is rotationally driven by working oil returned from an actuator, and regenerated electric power generated by a power generator provided coaxially to the regeneration motor is charged into a battery. Moreover, this hybrid construction machine includes an assist pump coupled to the regeneration motor and the electric motor, which assist pump is capable of supplying working oil to the actuator.

### SUMMARY OF INVENTION

In the hybrid construction machine described in JP2014-37861A, when just the assist control that causes the assist pump to drive is performed, a tilting angle of the assist pump is controlled as appropriate to allow discharge of a target assist flow rate in response to an operated amount of the actuator. Meanwhile, when regeneration control is performed simultaneously with the assist control, a tilting angle and a rotational speed of the assist pump are controlled to a constant value to achieve a predetermined assist flow rate discharged from the assist pump. Therefore, the discharging amount of the assist pump does not vary even when a supplying pressure to the actuator, namely, the discharge pressure of the assist pump increases due to an increase in a load on the actuator, and the drive force to rotationally drive the assist pump increases together with the increase in the discharge pressure.

That is to say, when the regeneration control is performed simultaneously with the assist control, the drive force for rotationally driving the assist pump will become in excess as compared to a case in which just the assist control is performed. Therefore, when the regeneration control is performed simultaneously with the assist control, mostly all of the regenerated energy is consumed as the drive force of the assist pump, and a proportion that the regenerated energy is charged to the battery as electric power decreases. As a result, the system efficiency of the hybrid construction machine may decrease.

An object of the present invention is to improve the system efficiency of a hybrid construction machine, by appropriately limiting the drive force of the assist pump.

According to one aspect of the present invention, a control system for a hybrid construction machine includes a fluid pressure pump configured to supply a working fluid to a fluid pressure actuator; a regeneration motor configured to be rotationally driven by working fluid discharged and returned from the fluid pressure pump; a rotating electric machine coupled to the regeneration motor; an energy storage unit configured to store electric power generated by the rotating electric machine; a variable capacity type assist pump coupled to the regeneration motor and the rotating electric machine, the variable capacity type assist pump being capable of supplying working fluid to the fluid pressure actuator; and a control unit configured to control the assist pump so that a discharging amount of the assist pump becomes a target discharging amount. The control unit controls the assist pump or the rotating electric machine such that the pump drive force is not more than the pump drive force limited value when determining that a pump drive force applied on the assist pump is greater than a predetermined pump drive force limited value.

### BRIEF DESCRIPTION OF DRAWINGS

FIG. 1 is a circuit diagram showing a control system for a hybrid construction machine according to an embodiment of the present invention;

FIG. 2 is a flow chart of a drive force limiting control of an assist pump in a control system for hybrid construction machine;

FIG. 3 is a flow chart of a part continuing to the flow chart of FIG. 2;

FIG. 4 is a flow chart of a part continuing to the flow chart of FIG. 3;

FIG. 5 is a flow chart of a modification of a drive force limiting control of an assist pump in a control system for a hybrid construction machine;

FIG. 6 is a flow chart continuing to the flow chart of FIG. 5;

FIG. 7 is a flow chart continuing to the flow chart of FIG. 6;

FIG. 8 is a graph showing a correction coefficient with respect to a charged amount of a battery; and

FIG. 9 is a graph showing a correction coefficient with respect to a load on an actuator.

### DESCRIPTION OF EMBODIMENTS

Hereinafter, an embodiment of the present invention will be described with reference to the drawings.

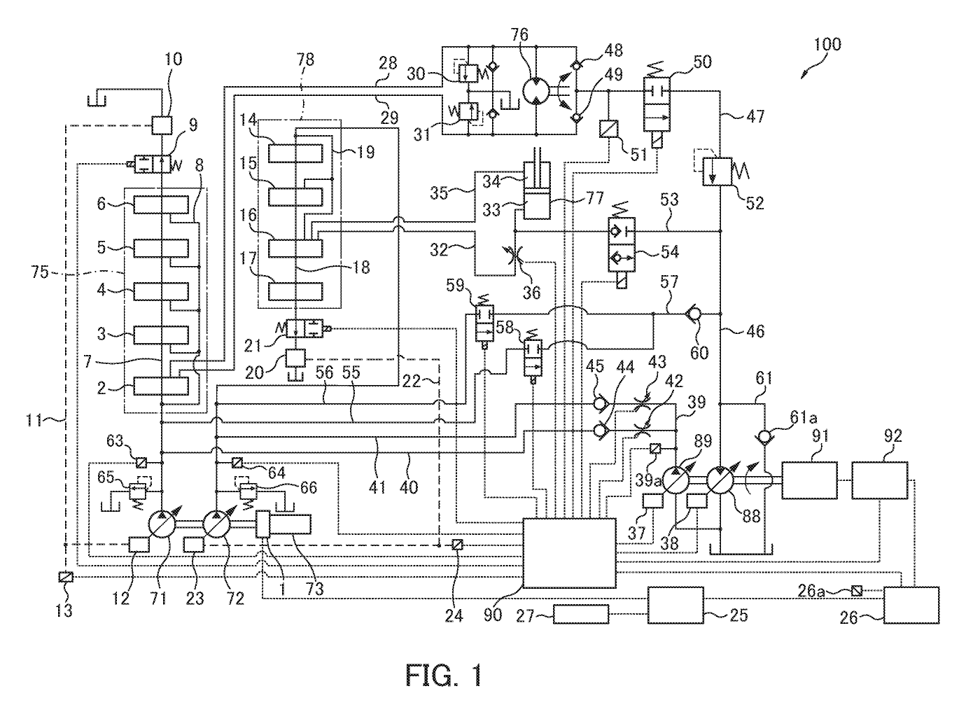

First, with reference to FIG. 1, an overall configuration of a control system 100 for a hybrid construction machine according to an embodiment of the present invention will be described. In the present embodiment, a case where the hybrid construction machine is a hydraulic excavator will be described. In the hydraulic excavator, working oil is used as working fluid.

The hydraulic excavator includes first and second main pumps 71 and 72 serving as fluid pressure pumps. Each of the first and second main pumps 71 and 72 is a variable capacity type pump in which a tilting angle of a swash plate can be adjusted. The first and second main pumps 71 and 72 are driven by an engine 73 and coaxially rotate.

A power generator 1 configured to generate electric power by utilizing remaining power of the engine 73 is provided in the engine 73. The electric power generated by the power generator 1 is charged into a battery 26 serving as an energy storage unit, via a battery charger 25. The battery charger 25 can charge the electric power into the battery 26 even in a case where the battery charger is connected to a normal household power source 27.

The battery 26 is provided with a temperature sensor 26a configured to detect a temperature of the battery 26, and a voltage sensor (not shown) configured to detect a voltage of the battery 26. The temperature sensor 26a outputs an electric signal in accordance with a detected temperature of the battery 26 to a controller 90 that serves as a control unit.

Working oil discharged from the first main pump 71 is supplied to a first circuit system 75. The first circuit system 75 has, in order from the upstream side, an operation valve 2 configured to control a swing motor 76, an operation valve 3 configured to control an arm cylinder (not shown), an operation valve 4 for boom second gear configured to control a boom cylinder 77, an operation valve 5 configured to control an auxiliary attachment (not shown), and an operation valve 6 configured to control a left-hand side first traveling motor (not shown). The swing motor 76, the arm cylinder, the boom cylinder 77, a hydraulic device connected to the auxiliary attachment, and the first traveling motor correspond to fluid pressure actuators (hereinafter, simply referred to as “actuators”).

The operation valves 2 to 6 control flow rates of discharged oil supplied from the first main pump 71 to the actuators, and control actions of the actuators. The operation valves 2 to 6 are operated by pilot pressure supplied in accordance with an operator of the hydraulic excavator manually operating an operation lever.

The operation valves 2 to 6 are connected to the first main pump 71 through a neutral flow passage 7 and a parallel flow passage 8 that are parallel to each other. On an upstream side of the operation valve 2 in the neutral flow passage 7, a first supply pressure sensor 63 is provided, which sensor detects pressure of the working oil supplied from the first main pump 71 into the neutral flow passage 7. Moreover, on an upstream side of the operation valve 2 in the neutral flow passage 7, a main relief valve 65 is provided, which main relief valve is configured to open when working oil pressure of the neutral flow passage 7 exceeds a predetermined main relief pressure, and maintains the working oil pressure equal to or below the main relief pressure.

On a downstream side of the operation valve 6 in the neutral flow passage 7, an on-off valve 9 is provided, which on-off valve has a solenoid to be connected to the controller 90, and which can block the working oil in the neutral flow passage 7. The on-off valve 9 is maintained at a full open position in a normal state. The on-off valve 9 is switched to a closed state by a command from the controller 90.

On the downstream side of the on-off valve 9 in the neutral flow passage 7, a pilot pressure generation mechanism 10 for generating pilot pressure is provided. The pilot pressure generation mechanism 10 generates high pilot pressure when a flow rate of a passing working oil is high, and generates low pilot pressure when the flow rate of the passing working oil is low.

In a case where all the operation valves 2 to 6 are placed at neutral positions or in the vicinity of the neutral positions, the neutral flow passage 7 guides all or part of the working oil discharged from the first main pump 71 to a tank. In this case, since the flow rate of the working oil passing through the pilot pressure generation mechanism 10 is increased, high pilot pressure is generated.

Meanwhile, when the operation valves 2 to 6 are switched to a full stroke state, the neutral flow passage 7 is closed and no working oil is distributed. In this case, the flow rate of the working oil passing through the pilot pressure generation mechanism 10 is almost eliminated, and the pilot pressure is maintained to be zero. However, depending on operated amounts of the operation valves 2 to 6, part of the working oil discharged from the first main pump 71 will be guided to the actuators, and remaining working oil will be guided to the tank from the neutral flow passage 7. Therefore, the pilot pressure generation mechanism 10 generates the pilot pressure in accordance with a flow rate of the working oil of the neutral flow passage 7. Namely, the pilot pressure generation mechanism 10 generates the pilot pressure in accordance with the operated amounts of the operation valves 2 to 6.

A pilot flow passage 11 is connected to the pilot pressure generation mechanism 10. The pilot pressure generated in the pilot pressure generation mechanism 10 is guided to the pilot flow passage 11. The pilot pressure generation mechanism 10 is connected to a regulator 12 configured to control a discharge capacity (tilting angle of a swash plate) of the first main pump 71.

The regulator 12 controls the tilting angle of the swash plate of the first main pump 71 in proportion to the pilot pressure of the pilot flow passage 11 (a proportional constant takes a negative number). Thereby, the regulator 12 controls displacement per rotation of the first main pump 71. Namely, the discharging amount of the first main pump 71 varies in accordance with the pilot pressure of the pilot flow passage 11. When the operation valves 2 to 6 are switched to full stroke and a flow of the neutral flow passage 7 is eliminated, and the pilot pressure of the pilot flow passage 11 becomes zero, the tilting angle of the first main pump 71 is maximized. At this time, the displacement per rotation of the first main pump 71 is maximized.

A first pressure sensor 13 configured to detect the pressure of the pilot flow passage 11 is provided in the pilot flow passage 11. Pressure detected by the first pressure sensor 13 is outputted to the controller 90 as a pressure signal.

The working oil discharged from the second main pump 72 is supplied to a second circuit system 78. The second circuit system 78 has, in order from the upstream side, an operation valve 14 configured to control a right-hand side second traveling motor (not shown), an operation valve 15 configured to control a bucket cylinder (not shown), an operation valve 16 configured to control a boom cylinder 77, and an operation valve 17 for arm second gear configured to control the arm cylinder (not shown). The second traveling motor, the bucket cylinder, the boom cylinder 77, and the arm cylinder correspond to fluid pressure actuators (hereinafter, simply referred to as the “actuators”).

The operation valves 14 to 17 control flow rates of discharged oil supplied from the second main pump 72 to the actuators, and control actions of the actuators. The operation valves 14 to 17 are operated by pilot pressure supplied in accordance with an operator of the hydraulic excavator manually operating the operation lever.

The operation valves 14 to 17 are connected to the second main pump 72 through a neutral flow passage 18 and a parallel flow passage 19 that are parallel to each other. On an upstream side of the operation valve 14 in the neutral flow passage 18, a second supply pressure sensor 64 is provided, which sensor detects pressure of working oil supplied from the second main pump 72 to the neutral flow passage 18. Moreover, on an upstream side of the operation valve 14 in the neutral flow passage 18, a main relief valve 66 is provided, which main relief valve is configured to open when working oil pressure of the neutral flow passage 18 exceeds a predetermined main relief pressure, and maintains the working oil pressure equal to or below the main relief pressure.

It should be noted that the main relief valves 65 and 66 may be only provided in at least one of the first circuit system 75 and the second circuit system 78. In a case where the main relief valve is provided in just one of the first circuit system 75 and the second circuit system 78, connection is established so that working oil is guided to the same main relief valve from the other one of the first circuit system 75 and second circuit system 78. As such, when a single main relief valve is provided, the main relief valve will be shared between the first circuit system 75 and the second circuit system 78. Moreover, in this case, just one supply pressure sensor is also provided, and is shared between the first circuit system 75 and the second circuit system 78.

On the downstream side of the operation valve 17 in the neutral flow passage 18, an on-off valve 21 is provided, which on-off valve has a solenoid to be connected to the controller 90, and which can block the working oil of the neutral flow passage 18. The on-off valve 21 is maintained at a full open position in a normal state. The on-off valve 21 is switched to a closed position in response to a command from the controller 90.

On the downstream side of the on-off valve 21 in the neutral flow passage 18, a pilot pressure generation mechanism 20 for generating pilot pressure is provided. The pilot pressure generation mechanism 20 has the same function as the pilot pressure generation mechanism 10 on the side of the first main pump 71.

A pilot flow passage 22 is connected to the pilot pressure generation mechanism 20. The pilot pressure generated in the pilot pressure generation mechanism 20 is guided to the pilot flow passage 22. The pilot flow passage 22 is connected to a regulator 23 configured to control a discharge capacity (tilting angle of a swash plate) of the second main pump 72.

The regulator 23 controls the tilting angle of the swash plate of the second main pump 72 in proportion to the pilot pressure of the pilot flow passage 22 (a proportional constant takes a negative number). Thereby, the regulator 23 controls a displacement per rotation of the second main pump 72. Namely, the discharging amount of the second main pump varies in accordance with the pilot pressure of the pilot flow passage 22. When the operation valves 14 to 17 are switched to full stroke and a flow of the neutral flow passage 18 is eliminated, and the pilot pressure of the pilot flow passage 22 becomes zero, the tilting angle of the second main pump 72 is maximized. At this time, the displacement per rotation of the second main pump 72 is maximized.

A second pressure sensor 24 configured to detect the pressure of the pilot flow passage 22 is provided in the pilot flow passage 22. Pressure detected by the second pressure sensor 24 is outputted to the controller 90 as a pressure signal.

Next, the swing motor 76 will be described.

Flow passages 28 and 29 that communicate with the swing motor 76 are connected to an actuator port of the operation valve 2. Relief valves 30 and 31 are connected to the flow passages 28 and 29, respectively. When the operation valve 2 is maintained in a neutral position, the actuator port is closed, and the swing motor 76 maintains a stopped state.

When the operation valve 2 is switched to one side from the neutral position in a state in which the swing motor 76 is stopped, the flow passage 28 becomes connected to the first main pump 71, and the flow passage 29 communicates with the tank. As a result, working oil is supplied from the flow passage 28 and the swing motor 76 rotates in one direction, and also return oil from the swing motor 76 returns to the tank through the flow passage 29. When the operation valve 2 is switched to the other side, the flow passage 29 becomes connected to the first main pump 71, and the flow passage 28 communicates with the tank. As a result, working oil is supplied from the flow passage 29 and the swing motor 76 rotates in the other direction, and also return oil from the swing motor 76 returns to the tank through the flow passage 28.

Next, the boom cylinder 77 will be described.

Flow passages 32 and 35 that communicate with the boom cylinder 77 are connected to an actuator port of the operation valve 16. When the operation valve 16 is maintained in the neutral position, the actuator port is closed, and the boom cylinder 77 maintains a stopped state.

When the operation valve 16 is switched to one side from the neutral position in a state in which the boom cylinder 77 is stopped, the working oil discharged from the second main pump 72 is supplied to a piston side chamber 33 of the boom cylinder 77 through the flow passage 32, and the return oil from a rod side chamber 34 returns to the tank through the flow passage 35. As a result, the boom cylinder 77 extends. When the operation valve 16 switches to the other side, the working oil discharged from the second main pump 72 is supplied to the rod side chamber 34 of the boom cylinder 77 through the flow passage 35, and the return oil from the piston side chamber 33 returns to the tank through the flow passage 32. As a result, the boom cylinder 77 contracts.

The operation valve 3 for boom second gear of the first circuit system 75 is switched in conjunction with the operation valve 16 in accordance with the operated amount of the boom operation lever. In the flow passage 32 connecting the piston side chamber 33 of the boom cylinder 77 with the operation valve 16, an electromagnetic proportional throttle valve 36 whose opening degree is controlled by the controller 90 is provided. The electromagnetic proportional throttle valve 36 is maintained at a full open position in a normal state.

The control system 100 for the hybrid construction machine includes a regeneration device configured to perform regeneration control that collects energy of working oil from the swing motor 76 and the boom cylinder 77. Hereinafter, the regeneration device will be described.

Regeneration control by the regeneration device is executed by the controller 90. The controller 90 includes a CPU (central processing unit) configured to execute the regeneration control, a ROM (read only memory) in which a control program, setting values, and the like required for processing actions of the CPU are stored, and a RAM (random access memory) configured to temporarily store information detected by various sensors.

First described is a swing regeneration control configured to perform energy regeneration by using working oil from the swing motor 76.

Flow passages 28 and 29 connected to the swing motor 76 are connected to a swing regeneration flow passage 47 for guiding working oil from the swing motor 76 to the regeneration motor 88 for regeneration. In the flow passages 28 and 29, check valves 48 and 49 are provided, respectively, which check valves are configured to allow only a flow of the working oil to the swing regeneration flow passage 47. The swing regeneration flow passage 47 is connected to the regeneration motor 88 through a joining regeneration flow passage 46.

The regeneration motor 88 is a variable capacity type motor in which a tilting angle of a swash plate can be adjusted, and is coupled to be coaxially rotatable to a motor generator 91 that serves as a rotating electric machine also serving as a power generator. The regeneration motor 88 is rotationally driven by working oil returned from the swing motor 76 and the boom cylinder 77 through the joining regeneration flow passage 46. Moreover, the regeneration motor 88, when performing an excess flow rate regeneration later described, is rotationally driven by working oil discharged and returned from the first and second main pumps 71 and 72. The tilting angle of the swash plate of the regeneration motor 88 is controlled by a tilting angle controller 38. The tilting angle controller 38 is controlled by an output signal of the controller 90.

The regeneration motor 88 can rotationally drive the motor generator 91. In a case where the motor generator 91 functions as a power generator, the regenerated electric power generated is charged into the battery 26 via an inverter 92. The regeneration motor 88 and the motor generator 91 may be directly coupled together or may be coupled via a reducer.

On the upstream of the regeneration motor 88, a pump-up passage 61 is connected, through which the working oil is pumped up from the tank to a joining regeneration flow passage 46 and supplied to the regeneration motor 88 in a case where an amount of supplied working oil to the regeneration motor 88 becomes insufficient. In the pump-up passage 61, a check valve 61a is provided, which check valve is configured to allow only a flow of the working oil from the tank to the joining regeneration passage 46.

In the swing regeneration flow passage 47, a solenoid switching valve 50 that is switched and controlled based on a signal outputted from the controller 90 is provided. Between the solenoid switching valve 50 and the check valves 48 and 49, a pressure sensor 51 is provided, which pressure sensor is configured to detect swing pressure at a time of a swinging action of the swing motor 76 or brake pressure at the time of a break action. The pressure detected by the pressure sensor 51 is outputted to the controller 90 as a pressure signal.

At the time of a brake action in which the operation valve 2 is switched to the neutral position while the swing motor 76 is swinging caused by the working oil supplied through the flow passages 28 and 29, the working oil discharged by a pump effect of the swing motor 76 flows into the swing regeneration flow passage 47 through the check valves 48 and 49, and is guided to the regeneration motor 88.

On the downstream side of the solenoid switching valve 50 in the swing regeneration flow passage 47, a safety valve 52 is provided. The safety valve 52 prevents the swing motor 76 from overrunning for example when an abnormality occurs to the solenoid switching valve 50 of the swing regeneration flow passage 47, by maintaining the pressure of the flow passages 28 and 29.

Upon judging that a pressure detected by the pressure sensor 51 is equal to or more than a swinging regeneration starting pressure Pt, the controller 90 energizes a solenoid of the solenoid switching valve 50. As a result, the solenoid switching valve 50 switches to the opened position to start the swing regeneration. When it is determined that the pressure detected by the pressure sensor 51 is less than the swinging regeneration starting pressure Pt, the controller 90 makes the solenoid of the solenoid switching valve 50 in a non-energized state. As a result, the solenoid switching valve 50 switches to the closed position, and the swinging regeneration stops.

To perform the aforementioned swinging regeneration control, the controller 90 stores the swinging regeneration starting pressure Pt for determining whether or not it is in the swinging regeneration control state, and a swinging regeneration rotational speed Nr being a target rotational speed of the motor generator 91 at the time of performing the swinging regeneration control.

Next describes a boom regeneration control configured to perform energy regeneration by using working oil from the boom cylinder 77.

The boom regeneration flow passage 53 dividing from a part between the piston side chamber 33 and the electromagnetic proportional throttle valve 36 is connected to the flow passage 32. The boom regeneration flow passage 53 is a flow passage for guiding return working oil from the piston side chamber 33 to the regeneration motor 88. The swing regeneration flow passage 47 and the boom regeneration flow passage 53 join and connect to the joining regeneration flow passage 46.

In the boom regeneration flow passage 53, a solenoid switching valve 54 to be switched and controlled by a signal outputted from the controller 90 is provided. When the solenoid is not energized, the solenoid switching valve 54 is switched to a closed position (state shown in drawing), to block the boom regeneration flow passage 53. When the solenoid is energized, the solenoid switching valve 54 is switched to an opened position, to communicate the boom regeneration flow passage 53 and allow for only the flow of the working oil from the piston side chamber 33 to the joining regeneration flow passage 46.

The controller 90 determines whether the operator intends to extend or contract the boom cylinder 77 on the basis of a detection result of a sensor (not shown) configured to detect an operated direction and an operated amount of the operation valve 16. Upon determining an extending action of the boom cylinder 77, the controller 90 maintains the electromagnetic proportional throttle valve 36 at a full open position being the normal state, and maintains the solenoid switching valve 54 at a closed position. Meanwhile, when the controller 90 determines a contracting action of the boom cylinder 77, the controller 90 calculates a contracting speed of the boom cylinder 77 requested by the operator in accordance with the operated amount of the operation valve 16, and closes the electromagnetic proportional throttle valve 36 to switch the solenoid switching valve 54 to the opened position. Thereby, all the return working oil from the boom cylinder 77 is guided to the regeneration motor 88, and the boom regeneration is performed.

The controller 90 stores a boom regeneration rotational speed Nb, which rotational speed Nb is a target rotational speed of the motor generator 91 of when the aforementioned boom regeneration control is performed.

Next described is an excess flow rate regeneration control configured to perform energy regeneration by collecting energy from the working oil from the neutral flow passages 7 and 18. The excess flow rate regeneration control is performed by the controller 90, similarly with the swing regeneration control and the boom regeneration control.

Flow passages 55 and 56 are connected to the first and second main pumps 71 and 72, respectively. Solenoid valves 58 and 59 are provided in the flow passages 55 and 56, respectively. The flow passages 55 and 56 are connected on upstream sides of the first and second circuit systems 75 and 78 to the first and second main pumps 71 and 72, respectively. The solenoid valves 58 and 59 have solenoids to be connected to the controller 90.

The solenoid valves 58 and 59 are switched to a closed position (position as shown) when the solenoid is non-energized, and are switched to an opened position when the solenoid is energized. The solenoid valves 58 and 59 are connected to the regeneration motor 88 via a joining flow passage 57 and a check valve 60.

The controller 90 energizes the solenoid of the solenoid valve 58 when the controller 90 determines that a detected value of the first supply pressure sensor 63 is a value close to the main relief pressure of the main relief valve 65. As a result, the solenoid valve 58 switches to the opened position. At this time, the controller 90 energizes the solenoid of the on-off valve 9 to switch the on-off valve 9 to a closed state. As a result, the working oil discharged from the first main pump 71 to the tank through the main relief valve 65 is guided to the joining regeneration flow passage 46 through the flow passage 55, and the excess flow rate regeneration of the first circuit system 75 is performed.

Similarly, the controller 90 energizes the solenoid of the solenoid valve 59 when the controller 90 determines that a detected value of the second supply pressure sensor 64 is a value close to the main relief pressure of the main relief valve 66. As a result, the solenoid valve 59 switches to the opened position. At this time, the controller 90 energizes the solenoid of the on-off valve 21 to switch the on-off valve 21 to the closed state. As a result, the working oil discharged from the second main pump 72 to the tank through the main relief valve 66 is guided to the joining regeneration flow passage 46 through the flow passage 56, and the excess flow rate regeneration of the second circuit system 78 is performed.

As such, the working oil discharged from the first and second main pumps 71 and 72 is supplied to the regeneration motor 88 via the solenoid valves 58 and 59, and rotationally drives the regeneration motor 88. The regeneration motor 88 rotationally drives the motor generator 91 to generate power. The electric power generated by the motor generator 91 is charged into the battery 26 via the inverter 92. This performs the excess flow rate regeneration by the excess flow rate of the working oil discharged from the first and second main pumps 71 and 72.

Next described is an assist control configured to assist outputs of the first and second main pumps 71 and 72 by energy of the working oil discharged from the assist pump 89.

The assist pump 89 rotates coaxially with the regeneration motor 88. The assist pump 89 rotates by drive force of when using the motor generator 91 as an electric motor, and drive force by the regeneration motor 88. The rotational speed of the motor generator 91 is controlled by the controller 90 connected to the inverter 92. Moreover, a tilting angle of a swash plate of the assist pump 89 is controlled by a tilting angle controller 37. The tilting angle controller 37 is controlled by an output signal of the controller 90.

The discharge passage 39 of the assist pump 89 is divided into a first assist passage 40 joining to the discharge side of the first main pump 71 and a second assist passage 41 joining to the discharge side of the second main pump 72. The discharge flow passage 39 is provided with a pressure sensor 39a serving as a discharge pressure detecting unit that detects discharge pressure Pa of the assist pump 89. Pressure detected by the pressure sensor 39a is outputted to the controller 90 as a pressure signal.

First and second proportional solenoid throttle valves 42 and 43 whose opening degrees are controlled by output signals from the controller 90 are respectively provided to the first and second assist flow passages 40 and 41. Check valves 44 and 45 configured to allow only flows of the working oil from the assist pump 89 to the first and second main pumps 71 and 72 are respectively provided in the first and second assist flow passages 40 and 41, downstream of the first and second proportional solenoid throttle valves 42 and 43.

To perform the aforementioned assist control, the controller 90 stores, as an arithmetic expression or a map, an assist flow rate Qa with respect to a displaced amount (assist control command) of the operation valve 16 corresponding to an operated amount of the operation lever in a direction causing the boom cylinder 77 to extend and an assist flow rate Qa with respect to a displaced amount (assist control command) of operation valves 2, 3, 5, 6, 14, 15, 17 that correspond to operated amounts of the operation lever that operates the actuators, and stores an assist rotational speed Na serving as a target rotational speed of the motor generator 91 of when performing the assist control.

Next described is an assist pump drive force limit control that limits an assist pump drive force La as a pump drive force applied to rotationally drive the assist pump 89 in the control system 100 for the hybrid construction machine.

For example, while the assist control having a constant tilting angle a and rotational speed of the assist pump 89 is performed, when a supply pressure of the working oil to each of the actuators, that is to say, a discharge pressure of the assist pump 89, increases due to an increase in the load on the actuators, the assist pump drive force La that causes rotational driving of the assist pump 89 increases together with the increase in the discharge pressure. As such, when the assist pump drive force La applied for rotationally driving the assist pump 89 becomes excess when the assist control is to be performed, most of the energy regenerated by the regeneration motor 88 is consumed as the drive force of the assist pump 89 if during the regeneration control, and unless during the regeneration control, the electrical energy charged to the battery 26 will be wastefully consumed.

If the regeneration energy is wastefully consumed as such, the system efficiency of the hybrid construction machine will decrease. To prevent this, the present embodiment performs an assist pump drive force limiting control, in which the assist pump 89 or motor generator 91 is controlled to make the assist pump drive force La not exceed predetermined drive force limited values Lmax1, Lmax2, and Lmax3 described below when the assist pump drive force La of the assist pump 89 is greater than the drive force limited values Lmax1, Lmax2, and Lmax3.

To perform the assist pump drive force limit control, the controller 90 stores a first drive force limited value Lmax1 serving as a pump drive force limited value to limit the assist pump drive force La in a case in which the assist control is performed during boom regeneration control, a second drive force limited value Lmax2 serving as a pump drive force limited value to limit the assist pump drive force La in a case in which the assist control is performed during swinging regeneration control, and a third drive force limited value Lmax3 serving as a pump drive force limited value to limit the assist pump drive force La in a case in which just the assist control to rotationally drive the assist pump 89 by the motor generator 91 is performed and no boom regeneration control and swing regeneration control is performed.

These drive force limited values Lmax1, Lmax2, and Lmax3 prevent the assist pump drive force La from becoming in excess by having the assist pump drive force La limited to the drive force limited values Lmax1, Lmax2, and Lmax3, and are set to maintain the system efficiency of the hybrid construction machine in a high state.

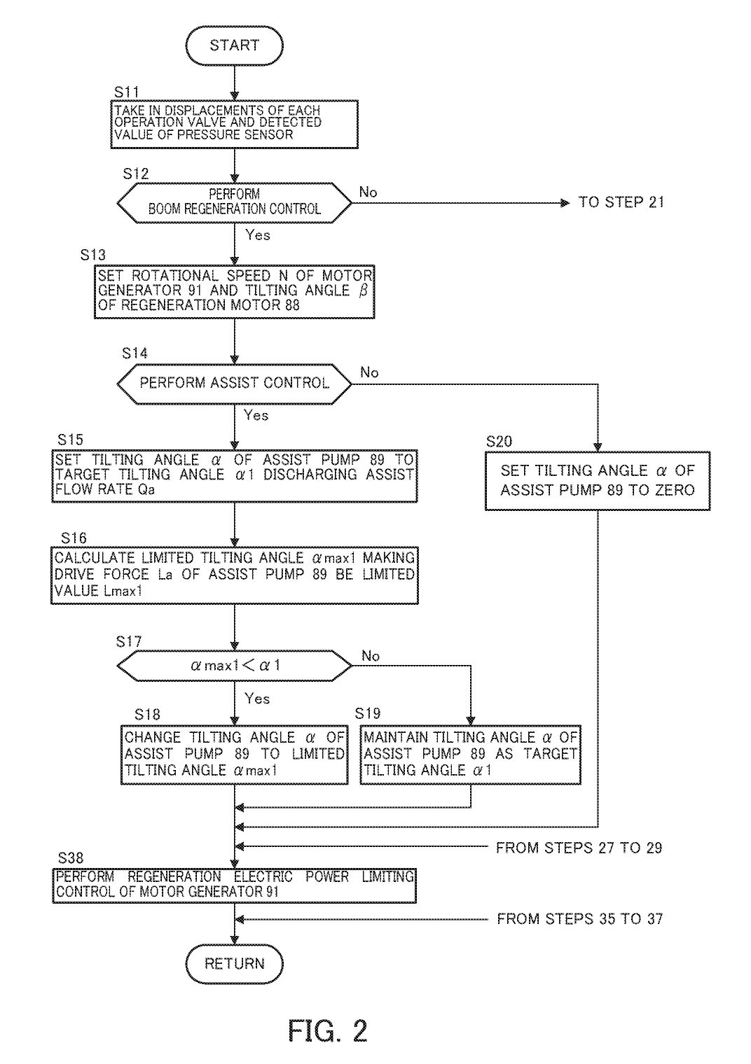

The following describes in details of the assist pump drive force limit control performed by the controller 90, with reference to flow charts shown in FIGS. 2 to 4.

Initially in step S11, the controller 90 takes in displacements of each operation valves 2 to 6 and 14 to 17 and a pressure value detected by the pressure sensor 51, to recognize how the hydraulic excavator is operated by the operator. It should be noted that the parameter taken in by the controller 90 in the present step is not limited to the displacements of the operation valves 2 to 6 and 14 to 17, and may be any parameter as long as it corresponds to the displacements of the operation valves 2 to 6 and 14 to 17, for example operated amounts of the operation levers operated by the operator.

Next, in step S12, the controller 90 determines whether or not to perform the boom regeneration control, namely, whether or not it is in a state possible to perform the boom regeneration control, on the basis of the displacement of the operation valve 16 of the boom cylinder 77 taken in at step S11. More specifically, when found out that the boom cylinder 77 is in a contracted state from the displaced amount and the displacement orientation of the operation valve 16, it is determined as in a state in which the boom regeneration control can be performed, and when found out that the boom cylinder 77 is in an extended state or a stopped state, it is determined as not in a state in which the boom regeneration control can be performed.

When it is determined that the boom regeneration control is performed in step S12, the procedure proceeds to step S13, and parameters necessary for the boom regeneration control are set at the controller 90. In step S13, the controller 90 calculates a boom regeneration flow rate Qb flowing into the regeneration motor 88 on the basis of the displaced amount of the operation valve 16, and sets a rotational speed N of the motor generator 91 to the predetermined boom regeneration rotational speed Nb. Furthermore, the controller 90 sets the tilting angle β of the regeneration motor 88 to a first tilting angle β1. The first tilting angle β1 is a tilting angle of when the flow rate of the working oil flowing into the regeneration motor 88 that rotates in sync with the motor generator 91 rotating at a boom regeneration rotational speed Nb becomes a calculated boom regeneration flow rate Qb. By setting the tilting angle β of the regeneration motor 88 to the first tilting angle β1 as such, the boom lowering speed is controlled to a predetermined speed.

In the following step S14, the controller 90 determines whether or not to perform assist control, that is to say, whether or not it is in a state that requires assistance with the assist pump 89, on the basis of the displaced amount of the operation valves 2 to 6, 14 to 17 taken in at step S11. More specifically, when there is the need to supply working oil from the assist pump 89 in addition to the first main pump 71 and second main pump 72 to any of the actuators due to a large displaced amount of any of the operation valves 2 to 6 and 14 to 17, it is determined that the assist control is necessary. Meanwhile, when the displaced amount of the operation valves 2 to 6 and 14 to 17 is small and the actuators can be driven sufficiently with the discharging amount by the first main pump 71 and the second main pump 72, it is determined that no assist control is necessary.

When it is determined that the assist control is performed in step S14, the procedure proceeds to step S15, and the assist flow rate Qa is calculated and the tilting angle α of the assist pump 89 is set at the controller 90. Meanwhile, when it is determined that it is not necessary to perform the assist control in step S14, the procedure proceeds to step S20, and the tilting angle α of the assist pump 89 is set as zero.

In step S15, the controller 90 calculates the assist flow rate Qa to be discharged from the assist pump 89 on the basis of the displaced amounts of the operation valves 2 to 6 and 14 to 17 using the stored arithmetic expression or map, and sets a tilting angle α of the assist pump 89 to a first target tilting angle α1 so that the discharging amount of the assist pump 89 becomes a calculated assist flow rate Qa. The first tilting angle α1 is a tilting angle of when the assist flow rate Qa is discharged, which assist flow rate Qa is calculated from the assist pump 89 that rotates in sync with the motor generator 91 rotating at the boom regeneration rotational speed Nb.

Furthermore, in step S16, the controller 90 calculates a first limited tilting angle αmax1 of when the assist pump drive force La of the assist pump 89 becomes the first drive force limited value Lmax1. More specifically, the controller 90 calculates the first limited tilting angle αmax1 from the following formula (1) by using a discharge pressure Pa of the assist pump 89 detected by the pressure sensor 39a, the assist flow rate Qa calculated in step S15, and the boom regeneration rotational speed Nb of the motor generator 91:

[Math. 1]

αmax1=κ1*Lmax1/(Pa*Nb) (1),

wherein, κ1 is a constant that is determined depending on a maximum displacement volume of the assist pump 89, a reduced ratio between the motor generator 91 and the assist pump 89, and a volume efficiency of the assist pump 89.

Step 17 compares the first target tilting angle α1 set in step S15 with the first limited tilting angle αmax1 calculated in step S16.

When the first target tilting angle α1 is greater than the first limited tilting angle αmax1, the assist pump drive force La of the assist pump 89 will exceed the first drive force limited value Lmax1, and will mean that the energy regenerated at the regeneration motor 88 is wastefully consumed. Therefore, when determined in step S17 that the first target tilting angle α1 is greater than the first limited tilting angle αmax1, the procedure proceeds to step S18, and the controller 90 changes the tilting angle α of the assist pump 89 to the first limited tilting angle αmax1. Although the flow rate discharged from the assist pump 89 decreases due to the decrease in the tilting angle α of the assist pump 89, the energy regenerated at the regeneration motor 88 is charged to the battery 26 as electric power by the amount the assist pump drive force La of the assist pump 89 is decreased. Moreover, when the assist pump 89 is rotationally driven by the regeneration motor 88 and the motor generator 91, namely, when the motor generator 91 is in a power running state, the electric power consumed by the motor generator 91 is reduced, and a decrease in the charged amount of the battery 26 is held down. As such, it is possible to appropriately control the assist pump drive force La by limiting the tilting angle α of the assist pump 89, and as a result, allows for improving the system efficiency of the hybrid construction machine.

Meanwhile, when determined in step S17 that the first target tilting angle α1 is not more than the first limited tilting angle αmax1, the procedure proceeds to step S19, and the controller 90 maintains the tilting angle α of the assist pump 89 to the first target tilting angle α1.

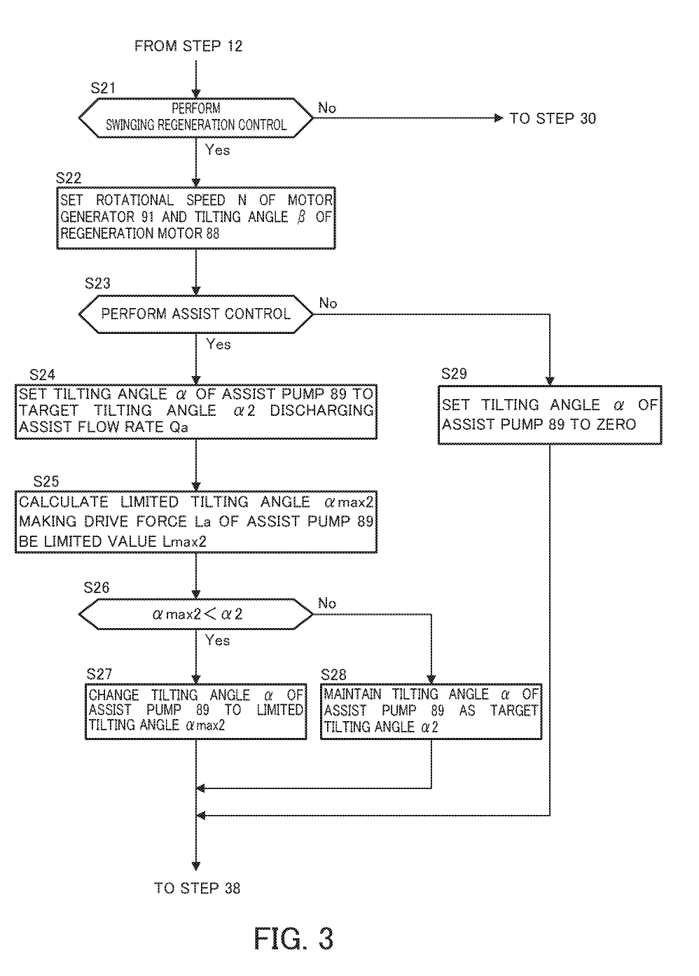

Next describes a case in which no boom regeneration control will be performed in step S12, with reference to FIG. 3.

When it is determined in step S12 as a state not possible to perform the boom regeneration control, the procedure proceeds to step S21, and the controller 90 determines whether or not to perform swinging regeneration control, that is to say, whether or not it is in a state possible to perform the swinging regeneration control. More specifically, the controller 90 determines as in a state possible to perform the swinging regeneration control when the detected value of the pressure sensor 51 taken in at step S11 is not less than the swinging regeneration starting pressure Pt, and determines as in a state not possible to perform the swinging regeneration control when the detected value of the pressure sensor 51 is less than the swinging regeneration starting pressure Pt.

When it is determined that the swinging regeneration control is performed in step S21, the procedure proceeds to step S22, and parameters necessary for the swinging regeneration control are set at the controller 90. In step S22, the controller 90 sets the rotational speed N of the motor generator 91 to a predetermined swinging regeneration rotational speed Nr, and sets the tilting angle β of the regeneration motor 88 that rotates in sync with the motor generator 91 rotating at the swinging regeneration rotational speed Nr to the second tilting angle β2. The second tilting angle β2 is set so that the detected value of the pressure sensor 51 maintains the swinging regeneration starting pressure Pt.

In the following step S23, the controller 90 determines whether or not to perform assist control, that is to say, whether or not it is in a state that requires assistance with the assist pump 89, on the basis of the displaced amount of the operation valves 2 to 6, 14 to 17 taken in at step S11. More specifically, when there is the need to supply working oil from the assist pump 89 in addition to the first main pump 71 and second main pump 72 to any of the actuators due to a large displaced amount of any of the operation valves 2 to 6 and 14 to 17, it is determined that the assist control is necessary. Meanwhile, when the displaced amount of the operation valves 2 to 6 and 14 to 17 is small and the actuators can be driven sufficiently with the discharging amount by the first main pump 71 and the second main pump 72, it is determined that no assist control is necessary.

When it is determined that the assist control is performed in step S23, the procedure proceeds to step S24, and the assist flow rate Qa is calculated and the tilting angle α of the assist pump 89 is set at the controller 90. Meanwhile, when it is determined that it is not necessary to perform the assist control in step S23, the procedure proceeds to step S29, and the tilting angle α of the assist pump 89 is set as zero.

In step S24, the controller 90 calculates the assist flow rate Qa to be discharged from the assist pump 89 on the basis of the displaced amounts of the operation valves 2 to 6 and 14 to 17 using the stored arithmetic expression or map, and sets the tilting angle α of the assist pump 89 to a second target tilting angle α2 so that the discharging amount of the assist pump 89 becomes the calculated assist flow rate Qa. The second target tilting angle α2 is a tilting angle of when the assist flow rate Qa is discharged, which assist flow rate Qa is calculated from the assist pump 89 that rotates in sync with the motor generator 91 rotating at a swinging regeneration rotational speed Nr.

Furthermore, in step S25, the controller 90 calculates a second limited tilting angle αmax2 of when the assist pump drive force La of the assist pump 89 becomes the second drive force limited value Lmax2. More specifically, the controller 90 calculates the second limited tilting angle αmax2 from the following formula (2) by using the discharge pressure Pa of the assist pump 89 detected by the pressure sensor 39a, the assist flow rate Qa calculated in step S24, and the swinging regeneration rotational speed Nr of the motor generator 91.

[Math. 2]

αmax2=κ1*Lmax2/(Pa*Nr) (2)

wherein, κ1 is a constant that is determined depending on a maximum displacement volume of the assist pump 89, a reduced ratio between the motor generator 91 and the assist pump 89, and a volume efficiency of the assist pump 89.

Step S26 compares the second target tilting angle α2 set in step S24 with the second limited tilting angle αmax2 calculated in step S25.

When the second target tilting angle α2 is greater than the second limited tilting angle αmax2, the assist pump drive force La of the assist pump 89 will exceed the second drive force limited value Lmax2, and means that the energy regenerated at the regeneration motor 88 is wastefully consumed. Therefore, when determined in step S26 that the second target tilting angle α2 is greater than the second limited tilting angle αmax2, the procedure proceeds to step S27, and the controller 90 changes the tilting angle of the assist pump 89 to the second limited tilting angle αmax2. Although the flow rate discharged from the assist pump 89 also decreases due to the decrease in the tilting angle of the assist pump 89, the energy regenerated at the regeneration motor 88 is charged to the battery 26 as electric power by the amount the assist pump drive force La of the assist pump 89 is reduced. Moreover, when the assist pump 89 is rotationally driven by the regeneration motor 88 and the motor generator 91, namely, when the motor generator 91 is in a power running state, the electric power consumed by the motor generator 91 is reduced, and a decrease in the charged amount of the battery 26 is held down. As such, it is possible to appropriately control the assist pump drive force La by limiting the tilting angle α of the assist pump 89, and as a result, allows for improving the system efficiency of the hybrid construction machine.

Meanwhile, when determined in step S26 that the second target tilting angle α2 is not more than the second limited tilting angle αmax2, the procedure proceeds to step S28, and the controller 90 maintains the tilting angle α of the assist pump 89 to the second target tilting angle α2.

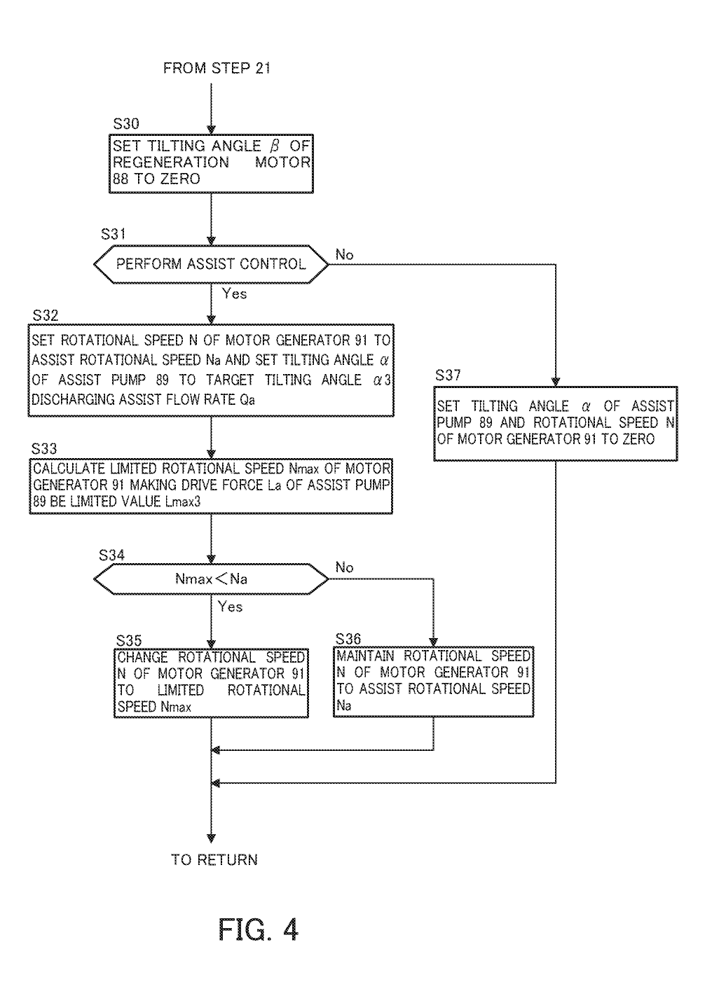

Next describes a case in which it is determined in step S21 that no swinging regeneration control will be performed, with reference to FIG. 4.

When it is determined in step S21 as not in a state possible to perform the swinging regeneration control, the procedure proceeds to step S30, and the controller 90 sets the tilting angle β of the regeneration motor 88 to zero, as a state in which no boom regeneration control nor swinging regeneration control is performed.

In the following step S31, the controller 90 determines whether or not to perform assist control, that is to say, whether or not it is in a state that requires assistance with the assist pump 89, on the basis of the displaced amount of the operation valves 2 to 6, 14 to 17 taken in at step S11. More specifically, when there is the need to supply working oil from the assist pump 89 in addition to the first main pump 71 and second main pump 72 to any of the actuators due to a large displaced amount of any of the operation valves 2 to 6 and 14 to 17, it is determined that the assist control is necessary. Meanwhile, when the displaced amount of the operation valves 2 to 6 and 14 to 17 is small and the actuators can be driven sufficiently with the discharging amount by the first main pump 71 and the second main pump 72, it is determined that no assist control is necessary.

When it is determined that the assist control is performed in step S31, the procedure proceeds to step S32, and the calculation of the assist flow rate Qa and settings of the rotational speed N of the motor generator 91 and the tilting angle α of the assist pump 89 are performed at the controller 90. Meanwhile, when it is determined that the assist control is not required to perform in step S31, the procedure proceeds to step S37, and the tilting angle a of the assist pump 89 and the rotational speed N of the motor generator 91 are set as zero.

In step S32, the controller 90 calculates the assist flow rate Qa to be discharged from the assist pump 89 on the basis of the displaced amounts of the operation valves 2 to 6 and 14 to 17 using a stored arithmetic expression or map and an assist rotational speed Na of the motor generator 91 that makes the assist pump 89 rotationally drive, and sets the tilting angle α of the assist pump 89 to a third target tilting angle α3 so that the discharging amount of the assist pump 89 becomes the calculated assist flow rate Qa. The third target tilting angle α3 is a tilting angle of when the calculated assist flow rate Qa is discharged from the assist pump 89 rotationally driven by the motor generator 91 that rotates at an assist rotating speed Na.

Furthermore, in step S33, the controller 90 calculates a limited rotational speed Nmax, which limited rotational speed Nmax is a rotational speed of the motor generator 91 when a motor output P serving as a rotating electric machine output, namely an output of the motor generator 91 that makes the assist pump 89 rotationally drive, that is to say, the assist pump drive force La of the assist pump 89, becomes the third drive force limited value Lmax3. More specifically, the controller 90 calculates an actual torque T of the motor generator 91 from an electric current value supplied from an inverter 92 to the motor generator 91, and calculates the limited rotational speed Nmax from the following formula (3):

[Math. 3]

Nmax=κ2*Lmax3/T (3),

wherein, κ2 is a constant.

Step S34 compares the assist rotational speed Na set in step S32 with the limited rotational speed Nmax calculated in step S33.

When the assist rotational speed Na is greater than the limited rotational speed Nmax, the motor output P of the motor generator 91 that makes the assist pump 89 to rotationally drive, that is to say, the assist pump drive force La of the assist pump 89 will exceed the third drive force limited value Lmax3, and means that the energy stored in the battery 26 is wastefully consumed. Therefore, when determined in step S34 that the assist rotational speed Na is greater than the limited rotational speed Nmax, the procedure proceeds to step S35, and the controller 90 changes the rotational speed N of the motor generator 91 to the limited rotational speed Nmax. Although the flow rate discharged from the assist pump 89 also decreases as the rotational speed N of the motor generator 91 decreases, the reduction in charged amount of the battery 26 is held down by the amount the electric power consumed by the motor generator 91 that makes the assist pump 89 rotationally drive is reduced. As such, it is possible to appropriately control the assist pump drive force La by limiting the rotational speed N of the motor generator 91, and as a result, can improve the system efficiency of the hybrid construction machine.

Meanwhile, when determined in step S34 that the assist rotational speed Na is not more than the limited rotational speed Nmax, the procedure proceeds to step S36, and the controller 90 maintains the rotational speed N of the motor generator 91 to the assist rotational speed Na.

In step S34, whether or not the assist pump drive force La of the assist pump 89 has reached a limit value is determined by comparing the rotational speed of the motor generator 91, and changes or maintains the rotational speed of the motor generator 91 in accordance with the determined result. Instead of this, the tilting angle of the assist pump 89 may be compared as in step S17 and step S26, and the tilting angle of the assist pump 89 may be changed or maintained in accordance with the determined result.

However, pumping efficiency of the assist pump 89 decreases as the tilting angle decreases. Therefore, when the tilting angle of the assist pump 89 is made smaller to limit the assist pump drive force La, the overall system efficiency of the hybrid construction machine may decrease caused by the decrease in the pumping efficiency. Moreover, when no regeneration control is performed and just the assist control is performed, no effect is given on the regeneration efficiency even when the rotational speed of the motor generator 91 is changed. Furthermore, with the variable capacity type pump, although there is a hysteresis feature in the change in tilting angle and thus the tilting angle may not change as commanded, changes in the rotational speed of the motor generator 91 will be performed electrically and thus will have good accuracy and responsiveness. For these reasons, it is more preferable in step S34 and step S35 to compare and change the rotational speed of the motor generator 91, not the tilting angle of the assist pump 89.

Once the processes in steps S18 to S20 and steps S27 to S29 terminate, the procedure proceeds to step S38 as shown in FIG. 2. In step S38, the controller 90 performs control to limit the regenerated electric power of the motor generator 91.

For example, when the charged amount of the battery 26 is high, all of the electric energy generated by the motor generator 91 at the time of regeneration control may not be recovered to the battery 26. Therefore, when such a state can be assumed in step S38, the controller 90 adjusts as appropriate the tilting angle α of the assist pump 89 and the tilting angle β of the regeneration motor 88 to limit the power generated amount of the motor generator 91. Performing the adjustment for limiting the power generated amount by the motor generator 91 is not limited to the tilting angle α of the assist pump 89 nor the tilting angle β of the regeneration motor 88, and may also be performed to the proportional solenoid throttle valve 36 and the opening degrees of the solenoid switching valves 50 and 54.

Once the processes in steps S35 to S38 terminate, the procedure returns back to the start again, and the controller 90 repeatedly performs the processes in the flow chart shown in FIGS. 2 to 4 while the hybrid construction machine is driven by the operator.

According to the above embodiment, the following effects are exerted.

In the control system 100 for the hybrid construction machine, the assist pump drive force La applied on the assist pump 89 is limited to be not more than the predetermined drive force limited values Lmax1, Lmax2, and Lmax3. As such, by preventing the assist pump drive force La from becoming in excess, the wasteful consumption of regeneration energy for rotationally driving the assist pump 89 is prevented, and thus allows for increasing the regeneration energy charged into the battery 26 as electric power. As a result, it is possible to improve the system efficiency of the hybrid construction machine.

Next describes a modification of the above embodiment.

In the above embodiment, step S17 compares the first target tilting angle α1 of the assist pump 89 with the first limited tilting angle αmax1.

Instead of this, the first assist pump drive force La1 being the actual drive force of the assist pump 89 may be calculated, and the first assist pump drive force La1 may be compared with the first drive force limited value Lmax1.

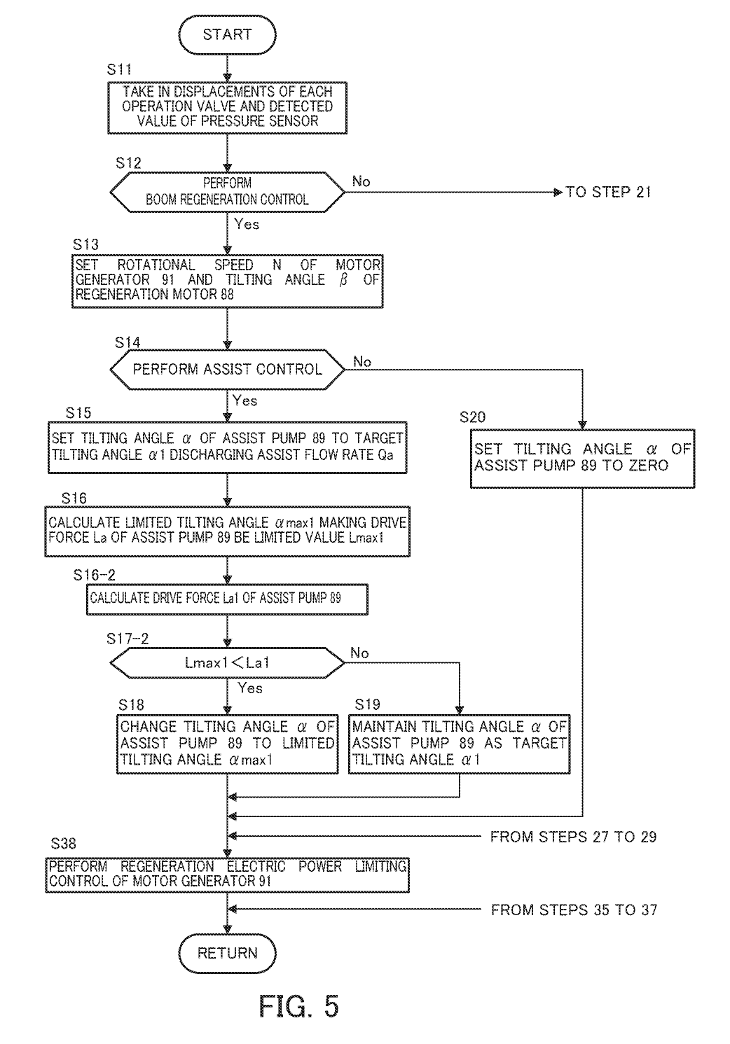

More specifically, as shown in FIG. 5, after the termination of the process of step S16, the controller 90, in step S16-2, calculates the first assist pump drive force La1 being the actual drive force of the assist pump 89 that rotates in sync with the motor generator 91 rotating at the boom regeneration rotational speed Nb. The first assist pump drive force La1 is calculated from the following formula (4) by using the discharge pressure Pa of the assist pump 89 detected by the pressure sensor 39a, the first target tilting angle α1 calculated in step S15, and the boom regeneration rotational speed Nb of the motor generator 91:

[Math. 4]

La1=κ3*Pa*α1*Nb (4),

wherein, κ3 is a constant that is determined depending on a maximum displacement volume of the assist pump 89, a reduced ratio between the motor generator 91 and the assist pump 89, and a volume efficiency of the assist pump 89, and the first target tilting angle α1 is a numerical value within a range shown as 0≤α1≤1.

In the subsequent step S17-2, the first assist pump drive force La1 is compared with the first drive force limited value Lmax1.

When determined in step S17-2 that the first assist pump drive force La1 is greater than the first drive force limited value Lmax1, the procedure proceeds to step S18, and the controller 90 changes the tilting angle α of the assist pump 89 to the first limited tilting angle αmax1. Meanwhile, when determined in step S17-2 that the first assist pump drive force La1 is not more than the first drive force limited value Lmax1, the procedure proceeds to step S19, and the controller 90 maintains the tilting angle α of the assist pump 89 as the first target tilting angle α1.

Moreover, in the above embodiment, step S26 compares the second target tilting angle α2 of the assist pump 89 with the second limited tilting angle αmax 2. Instead of this, the second assist pump drive force La2 being the actual drive force of the assist pump 89 may be calculated, and the second assist pump drive force La2 may be compared with the second drive force limited value Lmax2.

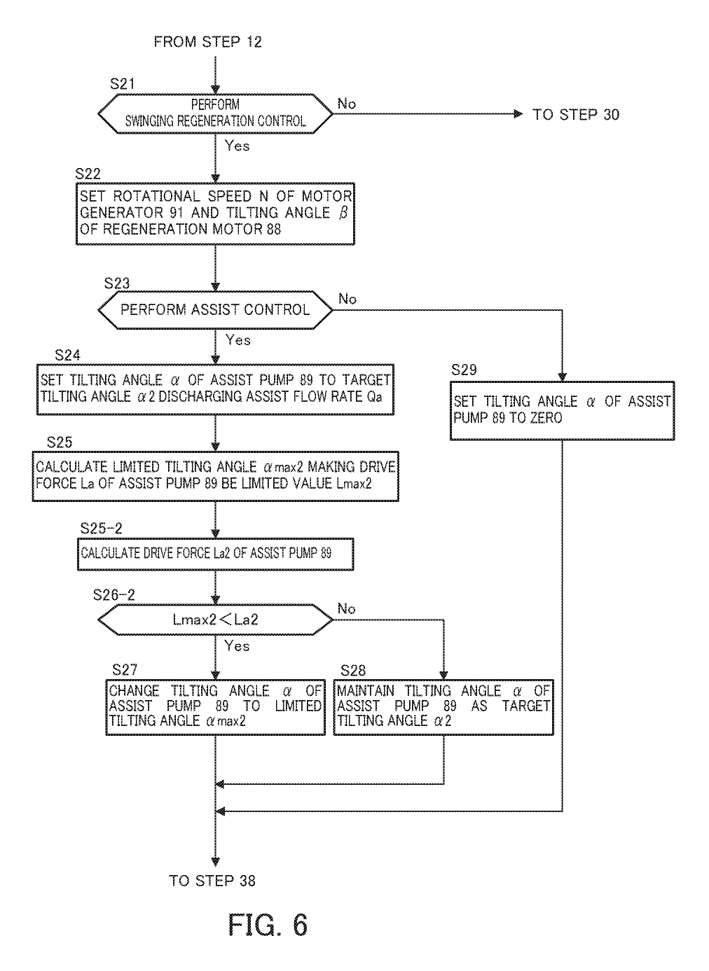

More specifically, as shown in FIG. 6, after the termination of the process of step S25, the controller 90, in step S25-2, calculates the second assist pump drive force La2 being the actual drive force of the assist pump 89 that rotates in sync with the motor generator 91 rotating at the swinging regeneration rotational speed Nr. The second assist pump drive force La2 is calculated from the following formula (5) by using the discharge pressure Pa of the assist pump 89 detected by the pressure sensor 39a, the second target tilting angle α2 calculated in step S24, and the swinging regeneration rotational speed Nr of the motor generator 91:

[Math. 5]

La2=κ3*Pa*α2*Nr (5),

wherein, κ3 is a constant that is determined depending on a maximum displacement volume of the assist pump 89, the reduced ratio between the motor generator 91 and the assist pump 89, and the volume efficiency of the assist pump 89, and the second target tilting angle α2 is a numerical value within a range shown as 0≤α2≤1.

In the subsequent step S26-2, the second assist pump drive force La2 is compared with the second drive force limited value Lmax2.

When determined in step S26-2 that the second assist pump drive force La2 is greater than the second drive force limited value Lmax2, the procedure proceeds to step S27, and the controller 90 changes the tilting angle a of the assist pump 89 to the second limited tilting angle αmax2. Meanwhile, when determined in step S26-2 that the second assist pump drive force limited value Lmax2 is not more than the second drive force limited value Lmax2, the procedure proceeds to step S28, and the controller 90 maintains the tilting angle α of the assist pump 89 to the second target tilting angle α2.

Moreover, in the above embodiment, step S34 compares the assist rotational speed Na of the motor generator 91 with the limited rotational speed Nmax. Instead of this, an actual motor output La3 being an actual output of the motor generator 91 corresponding to the actual drive force of the assist pump 89 may be calculated, and the actual motor output La3 may be compared with the third drive force limited value Lmax3.

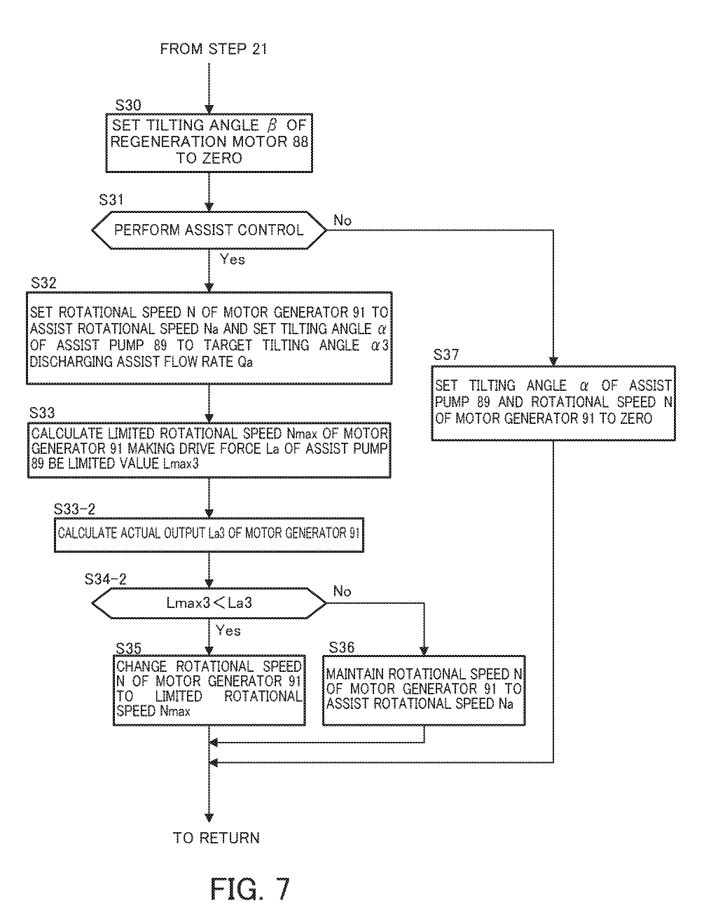

More specifically, as shown in FIG. 7, after the termination of the process of step S33, the controller 90, in step S33-2, calculates the actual motor output La3 being the actual output of the motor generator 91. The actual motor output La3 is calculated from the following formula (6) by using the assist rotational speed Na set in step S32, and an actual torque T of the motor generator 91 calculated from an electric current value supplied from the inverter 92 to the motor generator 91:

[Math. 6]

La3=κ4*T*Na (6)

wherein, κ4 is a constant.

In the subsequent step S34-2, the actual motor output La3 is compared with the third drive force limited value Lmax3.

When determined in step S34-2 that the actual motor output La3 is greater than the third drive force limited value Lmax3, the procedure proceeds to step S35, and the controller 90 changes the rotational speed N of the motor generator 91 to the limited rotational speed Nmax. Meanwhile, when determined in step S34-2 that the actual motor output La3 is not more than the third drive force limited value Lmax3, the procedure proceeds to step S36, and the controller 90 maintains the rotational speed N of the motor generator 91 as the assist rotational speed Na.

Moreover, in the above embodiment, each of the drive force limited values Lmax1, Lmax2, and Lmax3 are set to certain values. Instead of this, the drive force limited values Lmax1, Lmax2, and Lmax3 may vary in accordance with the temperature of the battery 26, the charged amount of the battery 26, or the load on the actuator.

For example, with the battery 26 of a form generally accompanying a chemical reaction, the charging and releasing efficiency largely decreases in low temperature areas and high temperature areas. Therefore, in areas where the temperature of the battery 26 is lower than a predetermined lower limit value T1 and areas where the temperature of the battery 26 is higher than a predetermined upper limit T2, the drive force limited values Lmax1 and Lmax2 at the time of regeneration is varied in accordance with the regeneration output of the regeneration motor 88 to prevent charging and discharging of electric power between the motor generator 91 and the battery 26, to cause the assist pump 89 to be driven just by the energy regenerated by the regeneration motor 88.

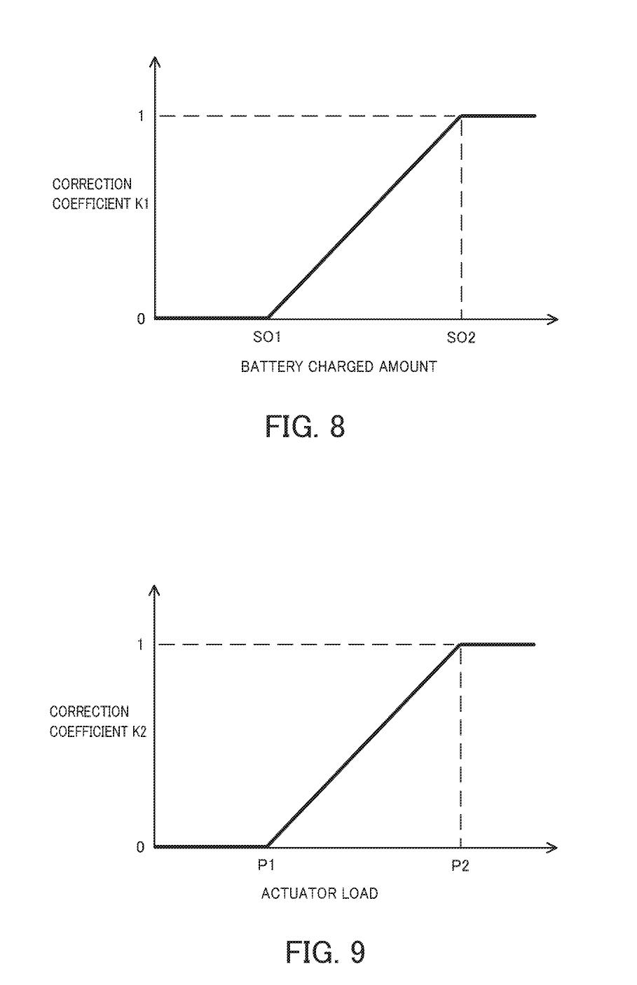

Moreover, when a stored amount SO of the battery 26 is low, the power generation by the motor generator 91 is prioritized, and when the stored amount SO of the battery 26 is high, the power generation by the motor generator 91 needs to be held down. Therefore, as shown in FIG. 8, a correction coefficient K1 that varies in accordance with the stored amount SO of the battery 26 may be set, and the drive force limited values Lmax1 and Lmax2 at the time of regeneration may be multiplied with the correction coefficient K1. In this case, the correction coefficient K1 becomes zero for cases not more than the first stored amount SO1, and thus the drive force limited values Lmax1 and Lmax2 become zero, and the discharging amount from the assist pump 89 becomes zero. As a result, the energy regenerated by the regeneration motor 88 is stored in the battery 26 as electric power. Meanwhile, the correction coefficient K1 becomes one for cases not less than the second stored amount SO2, and the proportion among the energy regenerated by the regeneration motor 88 that will serve as the assist pump drive force La of the assist pump 89 increases. As a result, the power generation by the motor generator 91 is held down.

Moreover, when the load on the actuator is high, that is to say, when the discharging amounts from the first main pump 71 and the second main pump 72 are relatively great, there is the need to increase the discharging amount from the assist pump 89, whereas when the load on the actuator is low, that is to say, when the discharging amounts from the first main pump 71 and the second main pump 72 are relatively low, no discharging amount from the assist pump 89 is required. Therefore, as shown in FIG. 9, a correction coefficient K2 that varies in accordance with the outputs of the first main pump 71 and the second main pump 72 may be set, and the correction coefficient K2 may be multiplied with the drive force limited values Lmax1, Lmax2, and Lmax3. In this case, the correction coefficient K2 becomes zero for cases not more than the first load P1, and thus the drive force limited values Lmax1, Lmax2, and Lmax3 become zero, and the discharging amount from the assist pump 89 becomes zero. Meanwhile, the correction coefficient K2 becomes one for cases not less than the second load P2, and thus the discharging amount from the assist pump 89 relatively increases.

Configurations, operations, and effects of the embodiment of the present invention will be summarized below.

The control system 100 for the hybrid construction machine includes: a first main pump 71 and a second main pump 72 configured to supply working oil to an actuator; a regeneration motor 88 configured to rotationally drive by the working oil discharged from the first main pump 71 and the second main pump 72 and returned; a motor generator 91 coupled to the regeneration motor 88; a battery 26 configured to store electric power generated by the motor generator 91; a variable capacity type assist pump 89 coupled to the regeneration motor 88 and the motor generator 91, being capable of supplying the working oil to the actuator; and a controller 90 configured to control the assist pump 89 to make a discharging amount of the assist pump 89 achieve a target discharging amount. The controller 90, when determining that an assist pump drive force La applied on the assist pump 89 is greater than predetermined drive force limited values Lmax1, Lmax2, and Lmax3, controls the assist pump 89 or the motor generator 91 to make the assist pump drive force La be not more than the drive force limited values Lmax1, Lmax2, and Lmax3.

In this configuration, the assist pump drive force La applied on the assist pump 89 is limited to be not more than the predetermined drive force limited values Lmax1, Lmax2, and Lmax3. As such, by preventing the assist pump drive force La from becoming in excess, the wasteful consumption of regeneration energy for rotationally driving the assist pump 89 is prevented, and thus allows for increasing the regeneration energy charged into the battery 26 as electric power. As a result, it is possible to improve the system efficiency of the hybrid construction machine.

Moreover, the control system 100 for the hybrid construction machine further includes a pressure sensor 39a configured to detect a discharge pressure of the assist pump 89. The controller 90 calculates target tilting angles α1 and α2 of the assist pump 89 allowing for the discharging amount of the assist pump 89 to achieve the target discharging amount and calculates limited tilting angles amaxl and αmax2 of the assist pump 89 of when the assist pump drive force La becomes the drive force limited values Lmax1 and Lmax2 on the basis of a detected value of the pressure sensor 39a, to compare the target tilting angles α1 and α2 with the limited tilting angles αmax1 and αmax2 and determine the assist pump drive force La as being greater than the drive force limited values Lmax1 and Lmax2 when the target tilting angles α1 and α2 are greater than the limited tilting angles αmax1 and αmax2.

In this configuration, the assist pump drive force La is determined as greater than the drive force limited values Lmax1 and Lmax2 when the target tilting angles α1 and α2 are greater than the limited tilting angles αmax1 and αmax2 calculated on the basis of the detected value of the pressure sensor 39a . When the rotational speed of the assist pump 89 is constant, the assist pump drive force La varies depending on the size of the tilting angle α. Therefore, by comparing the target tilting angles α1 and α2 of the assist pump 89 with the calculated limited tilting angles αmax1 and αmax2, whether or not the assist pump drive force La is greater than the drive force limited values Lmax1 and Lmax2 is determined easily.

Moreover, when determined that the assist pump drive force La is greater than the drive force limited values Lmax1 and Lmax2, the controller 90 controls to make the tilting angle α of the assist pump 89 to be not more than the limited tilting angle αmax1 and αmax2.

In this configuration, when determined that the assist pump drive force La is greater than the drive force limited values Lmax1 and Lmax2, the tilting angle α of the assist pump 89 is controlled to be not more than the limited tilting angles αmax1 and αmax2. When the tilting angle α of the assist pump 89 becomes small, the discharging amount of the assist pump 89 decreases and the assist pump drive force La is reduced. As such, the assist pump drive force La can be easily held down by changing the tilting angle α of the assist pump 89 that directly gives effect on the assist pump drive force La, and as a result, can easily prevent the regeneration energy from being wastefully consumed for rotationally driving the assist pump 89.

Moreover, the control system 100 for the hybrid construction machine further includes a pressure sensor 39a configured to detect a discharge pressure Pa of the assist pump 89, and the assist pump drive force La is calculated by the controller 90 on the basis of a detected value of the pressure sensor 39a.

In this configuration, the assist pump drive force La is calculated on the basis of the detected value of the pressure sensor 39a that detects the discharge pressure Pa of the assist pump 89. The drive force of the pump is generally calculated by the discharge pressure and the discharge flow rate. By providing the pressure sensor 39a that detects the discharge pressure Pa of the assist pump 89, the assist pump drive force La can be easily calculated, and allows for easily determining whether or not the assist pump drive force La is greater than the drive force limited values Lmax1 and Lmax2.

Moreover, when the controller 90 calculates the limited tilting angle αmax1 and αmax2 of the assist pump 89 of when the assist pump drive force La becomes the drive force limited values Lmax1 and Lmax2 on the basis of the detected value of the pressure sensor 39a and determines that the assist pump drive force La is greater than the drive force limited values Lmax1 and Lmax2, the controller 90 controls to make the tilting angle α of the assist pump 89 to be not more than the limited tilting angles αmax1 and αmax2.

In this configuration, when determined that the assist pump drive force La is greater than the drive force limited values Lmax1 and Lmax2, the tilting angle α of the assist pump 89 is controlled to be not more than the limited tilting angles αmax1 and αmax2. The variable capacity type assist pump 89 decreases in discharging amount and also the assist pump drive force La decreases, when the tilting angle α becomes small. As such, it is possible to easily hold down the assist pump drive force La by changing the tilting angle α that gives effect on the assist pump drive force La, and as a result, can easily prevent the regeneration energy from being wastefully consumed for rotationally driving the assist pump 89.

Moreover, the controller 90 calculates an assist rotational speed Na of the motor generator 91 of when the discharging amount of the assist pump 89 becomes the target discharging amount and calculates a limited rotational speed Nmax of the motor generator 91 of when a motor output P of the motor generator 91 (assist pump drive force La) becomes a predetermined third drive force limited value Lmax3, to compare the assist rotational speed Na with the limited rotational speed Nmax and determine the assist pump drive force La as being greater than the third drive force limited value Lmax3 when the assist rotational speed Na is greater than the limited rotational speed Nmax.

In this configuration, when the assist rotational speed Na of the motor generator 91 is greater than the limited rotational speed Nmax, the assist pump drive force La is determined as greater than the third drive force limited value Lmax3. When the assist pump 89 is driven just by the motor generator 91, the output of the motor generator 91 corresponds to the assist pump drive force La. Moreover, generally, the output is correlated to the rotational speed. Therefore, by comparing the assist rotational speed Na of the motor generator 91 with the limited rotational speed Nmax, it is possible to easily determine whether or not the assist pump drive force La is greater than the third drive force limited value Lmax3.

Moreover, when determined that the assist pump drive force La is greater than the third drive force limited value Lmax3, the controller 90 controls to make the rotational speed N of the motor generator 91 to be not more than the limited rotational speed Nmax.

In this configuration, when determined that the assist pump drive force La is greater than the third drive force limited value Lmax3, the rotational speed N of the motor generator 91 is controlled to be not more than the limited rotational speed Nmax. When the rotational speed N of the motor generator 91 being the electric motor decreases, the rotational speed and the discharging amount of the assist pump 89 also decreases, and further the assist pump drive force La decreases. As such, by changing the rotational speed N of the motor generator 91 that gives effect on the assist pump drive force La, the assist pump drive force La can be easily held down, and as a result, can easily prevent the regeneration energy from being wastefully consumed for rotationally driving the assist pump 89.

Moreover, the controller 90 calculates an actual motor output La3 of the motor generator 91 that rotationally drives the assist pump 89, and determines that the assist pump drive force La is greater than the third drive force limited value Lmax3 when the actual motor output La3 is greater than the predetermined third drive force limited value Lmax3.

In this configuration, the assist pump drive force La is determined as greater than the third drive force limited value Lmax3 when the actual motor output La3 is greater than the predetermined third drive force limited value Lmax3. When the assist pump 89 is driven just by the motor generator 91, the actual motor output La3 of the motor generator 91 corresponds to the assist pump drive force La. Therefore, by comparing the actual motor output La3 of the motor generator 91 with the third drive force limited value Lmax3, it is possible to easily determine whether or not the assist pump drive force La is greater than the third drive force limited value Lmax3.

Moreover, the controller 90 calculates the limited rotational speed Nmax of the motor generator 91 of when the rotating electric machine output becomes the third drive force limited value Lmax3, and when determined that the assist pump drive force La is greater than the third drive force limited value Lmax3, the controller 90 controls to make the rotational speed N of the motor generator 91 to be not more than the limited rotational speed Nmax.

In this configuration, when determined that the assist pump drive force La is greater than the third drive force limited value Lmax3, the rotational speed N of the motor generator 91 is controlled to be not more than the limited rotational speed Nmax. When the rotational speed N of the motor generator 91 serving as the electric motor decreases, the rotational speed and the discharging amount of the assist pump 89 also decreases, and further the assist pump drive force La decreases. As such, by changing the rotational speed N of the motor generator 91 that gives effect on the assist pump drive force La, the assist pump drive force La can be easily held down, and as a result, can easily prevent the regeneration energy from being wastefully consumed for rotationally driving the assist pump 89.

Moreover, the control system 100 for the hybrid construction machine further includes a pressure sensor 39a configured to detect the discharge pressure of the assist pump 89. The controller 90, when the regeneration motor 88 is rotationally driven by the working oil, calculates target tilting angles α1 and α2 of the assist pump 89 allowing for the discharging amount of the assist pump 89 to achieve the target discharging amount, calculates limited tilting angles αmax1 and αmax2 of the assist pump 89 of when the assist pump drive force La becomes the drive force limited values Lmax1 and Lmax2 on the basis of a detected value of the pressure sensor 39a, to compare the target tilting angles α1 and α2 with the limited tilting angles αmax1 and αmax2 and determine the assist pump drive force La as being greater than the drive force limited values Lmax1 and Lmax2 when the target tilting angles α1 and α2 are greater than the limited tilting angles αmax1 and αmax2, and when the regeneration motor 88 is not rotationally driven by the working oil, calculates the assist rotational speed Na of the motor generator 91 allowing for the discharging amount of the assist pump 89 to achieve the target discharging amount and calculates the limited rotational speed Nmax of the motor generator 91 of when the motor output P of the motor generator 91 (assist pump drive force La) becomes the predetermined third drive force limited value Lmax3, to compare the assist rotational speed Na with the limited rotational speed Nmax and determine the assist pump drive force La as being greater than the third drive force limited value Lmax3 when the assist rotational speed Na is greater than the limited rotational speed Nmax.

In this configuration, when the regeneration motor 88 is rotationally driven by the working oil, the assist pump drive force La is determined as greater than the drive force limited values Lmax1 and Lmax2 when the target tilting angles α1 and α2 are greater than the limited tilting angles αmax1 and αmax2 calculated on the basis of the detected value of the pressure sensor 39a, and when the regeneration motor 88 is not rotationally driven by the working oil, the assist pump drive force La is determined as greater than the third drive force limited value Lmax3 when the assist rotational speed Na of the motor generator 91 is greater than the limited rotational speed Nmax. When the rotational speed of the assist pump 89 that is rotationally driven by the regeneration motor 88 is constant, the assist pump drive force La varies depending on the tilting angle a. Therefore, by comparing the target tilting angles α1 and α2 of the assist pump 89 with the calculated limited tilting angles αmax1 and αmax2, whether or not the assist pump drive force La is greater than the drive force limited values Lmax1 and Lmax2 can be determined easily. Moreover, when the assist pump 89 is driven just by the motor generator 91, the output of the motor generator 91 corresponds to the assist pump drive force La. Moreover, generally, the output is correlated to the rotational speed. Therefore, by comparing the assist rotational speed Na of the motor generator 91 with the limited rotational speed Nmax, it is possible to easily determine whether or not the assist pump drive force La is greater than the third drive force limited value Lmax3.

The embodiments of the present invention described above are merely illustration of some application examples of the present invention and not of the nature to limit the technical scope of the present invention to the specific constructions of the above embodiments.

The present application claims a priority based on Japanese Patent Application No. 2016-102747 filed with the Japan Patent Office on May 23, 2016, all the contents of which are hereby incorporated by reference.

1. A control system for a hybrid construction machine, comprising:
a fluid pressure pump configured to supply a working fluid to a fluid pressure actuator;
a regeneration motor configured to be rotationally driven by working fluid discharged and returned from the fluid pressure pump;
a rotating electric machine coupled to the regeneration motor;
an energy storage unit configured to store electric power generated by the rotating electric machine;
a variable capacity type assist pump coupled to the regeneration motor and the rotating electric machine, the variable capacity type assist pump being capable of supplying working fluid to the fluid pressure actuator; and
a control unit configured to control the assist pump so that a discharging amount of the assist pump becomes a target discharging amount, wherein the control unit controls the assist pump or the rotating electric machine such that the pump drive force is not more than the pump drive force limited value when determining that a pump drive force applied on the assist pump is greater than a predetermined pump drive force limited value.

2. The control system for the hybrid construction machine according to claim 1, further comprising
a discharge pressure detecting unit configured to detect a discharge pressure of the assist pump, wherein
the control unit is configured to calculate a target tilting angle of the assist pump at which the discharging amount of the assist pump becomes the target discharging amount, calculate a limited tilting angle of the assist pump of when the pump drive force becomes the pump drive force limited value on the basis of a detected value of the discharge pressure detecting unit, compare the target tilting angle with the limited tilting angle, and determine the pump drive force as being greater than the pump drive force limited value when the target tilting angle is greater than the limited tilting angle.

3. The control system for the hybrid construction machine according to claim 2, wherein
the control unit controls to make a tilting angle of the assist pump to be not more than the limited tilting angle when the pump drive force is determined as greater than the pump drive force limited value.

4. The control system for the hybrid construction machine according to claim 1, further comprising
a discharge pressure detecting unit configured to detect a discharge pressure of the assist pump, wherein
the pump drive force is configured to be calculated by the control unit on the basis of a detected value of the discharge pressure detecting unit.

5. The control system for the hybrid construction machine according to claim 4, wherein
the control unit is configured to calculate a limited tilting angle of the assist pump of when the pump drive force becomes the pump drive force limited value on the basis of the detected value of the discharge pressure detecting unit, and control to make the tilting angle of the assist pump to be not more than the limited tilting angle when the pump drive force is determined as greater than the pump drive force limited value.

6. The control system for the hybrid construction machine according to claim 1, wherein
the control unit is configured to calculate a target rotational speed of the rotating electric machine at which a discharging amount of the assist pump becomes the target discharging amount, calculate a limited rotational speed of the rotating electric machine of when a rotating electric machine output of the rotating electric machine becomes the pump drive force limited value, compare the target rotational speed with the limited rotational speed, and determine the pump drive force as being greater than the pump drive force limited value when the target rotational speed is greater than the limited rotational speed.

7. The control system for the hybrid construction machine according to claim 6, wherein
the control unit controls to make a rotational speed of the rotating electric machine to be not more than the limited rotational speed when the pump drive force is determined as greater than the pump drive force limited value.

8. The control system for the hybrid construction machine according to claim 1, wherein
the control unit is configured to calculate a rotating electric machine output of the rotating electric machine that rotationally drives the assist pump, and determine the pump drive force as being greater than the pump drive force limited value when the rotating electric machine output is greater than the pump drive force limited value.

9. The control system for the hybrid construction machine according to claim 8, wherein
the control unit is configured to calculate the limited rotational speed of the rotating electric machine of when the rotating electric machine output becomes the pump drive force limited value, and control to make the rotational speed of the rotating electric machine be not more than the limited rotational speed when the pump drive force is determined as greater than the pump drive force limited value.

10. The control system for the hybrid construction machine according to claim 1, further comprising
a discharge pressure detecting unit configured to detect a discharge pressure of the assist pump, wherein
when the regeneration motor is rotationally driven by working fluid, the control unit calculates a target tilting angle of the assist pump at which a discharging amount of the assist pump becomes the target discharging amount, calculates a limited tilting angle of the assist pump of when the pump drive force becomes the pump drive force limited value on the basis of a detected value of the discharge pressure detecting unit, compares the target tilting angle with the limited tilting angle, and determines the pump drive force as being greater than the pump drive force limited value when the target tilting angle is greater than the limited tilting angle, and
when the regeneration motor is not rotationally driven by working fluid, the control unit calculates a target rotational speed of the rotating electric machine at which the discharging amount of the assist pump becomes the target discharging amount, calculates a limited rotational speed of the rotating electric machine of when a rotating electric machine output of the rotating electric machine becomes the pump drive force limited value, compares the target rotational speed with the limit rotational speed, and determines the pump drive force as being greater than the pump drive force limited value when the target rotational speed is greater than the limited rotational speed.
